(19) United States
(12) Patent Application Publication
(10) Pub. No.: US 2013/0278320 A1
(43) Pub. Date: Oct. 24, 2013

(54) MIXER FOR MIXING INPUT SIGNAL WITH MULTIPLE OSCILLATING SIGNALS HAVING DIFFERENT PHASES AND RELATED MIXING METHOD THEREOF

(71) Applicants: Hsien-Ku Chen, Taoyuan County (TW); Chia-Jun Chang, Taipei City (TW); Ka-Un Chan, Hsinchu County (TW); Ying-Hsi Lin, Hsin-Chu City (TW)

(72) Inventors: Hsien-Ku Chen, Taoyuan County (TW); Chia-Jun Chang, Taipei City (TW); Ka-Un Chan, Hsinchu County (TW); Ying-Hsi Lin, Hsin-Chu City (TW)

(21) Appl. No.: 13/609,288

(22) Filed: Sep. 11, 2012

(30) Foreign Application Priority Data
Apr. 24, 2012 (TW) 101114497

(51) Int. Cl. G06G 7/12

(52) U.S. Cl. 327/355

(57) ABSTRACT

A mixer includes a transformer and a mixing circuit. The transformer is employed for receiving an input signal to generate a differential output. The mixing circuit is coupled to the transformer, and employed for mixing the differential output with N oscillating signals having different phases to generate a plurality of mixed output signals, wherein N is greater than 2.

### BACKGROUND OF THE INVENTION

1. Field of the Invention

The present invention relates to the field of wireless communication, and more particularly, to a mixer and mixing method for mixing an input signal with oscillating signals having multiple phases.

2. Description of the Prior Art

In the field of wireless communication, the mixer is an important and essential device required for converting signal frequency in receivers and transmitters. For example, the mixer in the receiver needs to down-convert the radio frequency signal received from the antenna and then to amplify it according to the local oscillating signal through the amplifier to obtain an intermediate frequency signal or a baseband signal for further demodulation.

A well-known structure of the mixer is the Gilbert cell structure. The Gilbert cell structure mixes the input signal with the oscillating signal via cascoded differential pairs, to increase the frequency of the input signal or decrease the frequency of the input signal to the target frequency band. However, using this structure often generates high-frequency distortion, especially in the case of mixing the input signal with oscillating signals having multiple phases. This is because that the Gilbert cell structure needs to use more differential pairs to implement the multiple-phase mixing. As a result, the equivalent capacitor at the input increases and the time constant also increases, resulting in a reduced bandwidth and a poor high-frequency response of the mixer. Consequently, the signal distortion problem occurs. As the input signal of the mixer may be the radio frequency signal with high frequency, the signal distortion problem will get worse.

### SUMMARY OF THE INVENTION

To solve the problem existing in the prior art, the present invention provides an innovative mixer structure and related mixing method. The present invention uses a transformer as an input stage of the mixer to provide the signal coupling function. As an inductive element in the transformer may resonate with an equivalent capacitor at the input node of the mixer, the mixer of the present invention still has a good high-frequency response under a multi-phase mixing condition.

An embodiment of the present invention provides a mixer. The mixer includes a transformer and a mixing circuit. The transformer is used to receive an input signal to generate a differential output. The mixing circuit is coupled to the transformer, and arranged for mixing the differential output with N oscillating signals having different phases to generate a plurality of mixed output signals, wherein N is greater than 2.

Another embodiment of the present invention provides a mixing method. The mixing method includes: using a transformer receiving an input signal to generate a differential output; and using a mixing circuit to mix the differential output with N oscillating signals having different phases to generate a plurality of mixed output signals, wherein N is greater than 2.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an embodiment of a mixer of the present invention.

FIG. 2 is a diagram illustrating another embodiment of a mixer of the present invention.

FIG. 3 is a diagram illustrating another embodiment of a mixer of the present invention.

FIG. 4 is a diagram illustrating another embodiment of a mixer of the present invention.

FIG. 5 is a detailed circuit diagram illustrating an embodiment of a mixer of the present invention.

FIG. 6 is a flowchart illustrating an embodiment of a mixing method of the present invention.

### DETAILED DESCRIPTION

In the following, technical features of the present invention are detailed using several embodiments with reference to drawings. Without departing from the general concept and scope of the present invention, these embodiments include modifications and alterations based on teachings of the present invention. Besides, the embodiments discussed hereinafter are described with reference to specific drawings. However, the contents illustrated in these drawings should not be regarded as limitations of the present invention. The elements/symbols with the same reference numeral in different drawings should be regarded as having similar/same definition, function or operational mode.

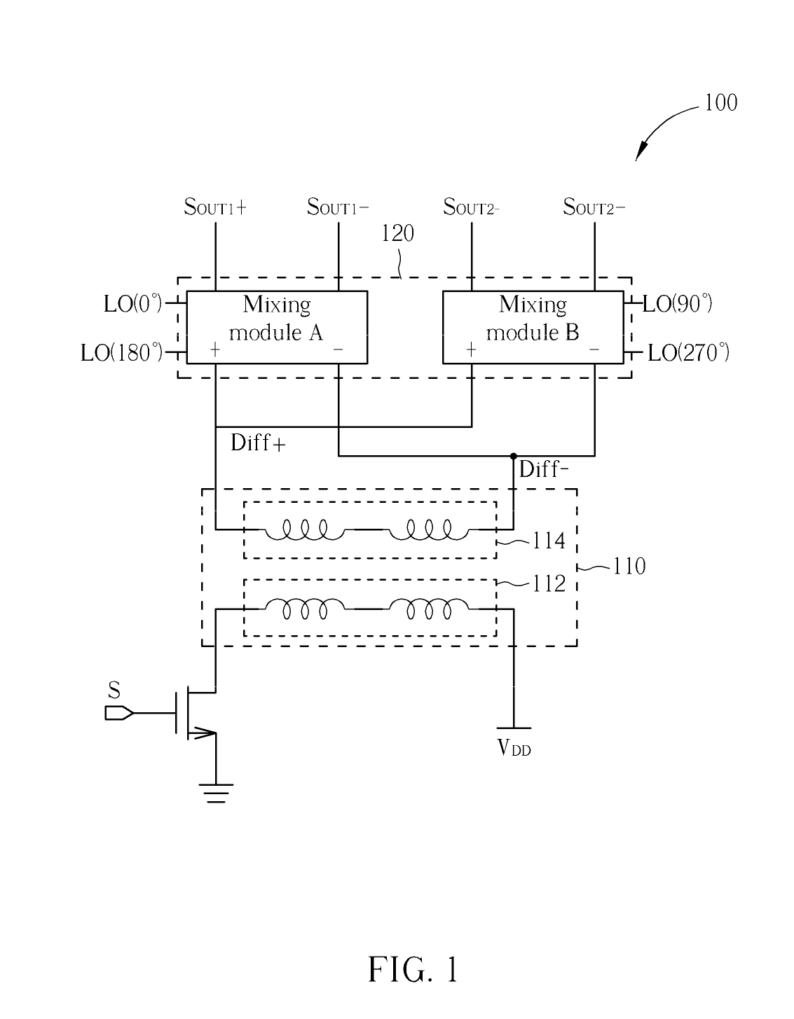

Please refer to FIG. 1, which is a diagram illustrating a simplified structure of a mixer according to an embodiment of the present invention. As shown in FIG. 1, the mixer 100 of the present invention includes a transformer 110 and a mixing circuit 120. The transformer 110 includes a first coil 112 and a second coil 114, and is arranged for transferring a single-ended input signal S into a differential output, wherein the differential output is composed of signals Diff+ and Diff−, and the first coil 112 and the second coil 114 may be implemented by any inductive elements. Signals Diff+ and Diff− may be inputted to the mixing module A and the mixing module B of the mixing circuit 120, respectively, and then mixed with oscillating signals LO(0), LO(90), LO(180) and LO(270), respectively, wherein the numbers in the brackets represent the relative relation of phases of the oscillating signals. In the mixing module A, the signals Diff+ and Diff− generated from the transformer 110 may be mixed with oscillating signals LO(0) and LO(180) to generate the mixed output SOUT1+ and SOUT1−. And in the mixing module B, the signals Diff+ and Diff− generated from the transformer 110 may be mixed with oscillating signals LO(90) and LO(270) to generate the mixed output SOUT2+ and SOUT2−. The oscillating signals LO(0) and LO(180) may be a set of differential oscillating signals having a 180-degree phase difference therebetween, and the oscillating signals LO(90) and LO(270) may be another set of differential oscillating signals having a 180-degree phase difference therebetween. Such a mixing structure may be used to implement the mixer required in the orthogonal frequency-division multiplexing (OFDM) system.

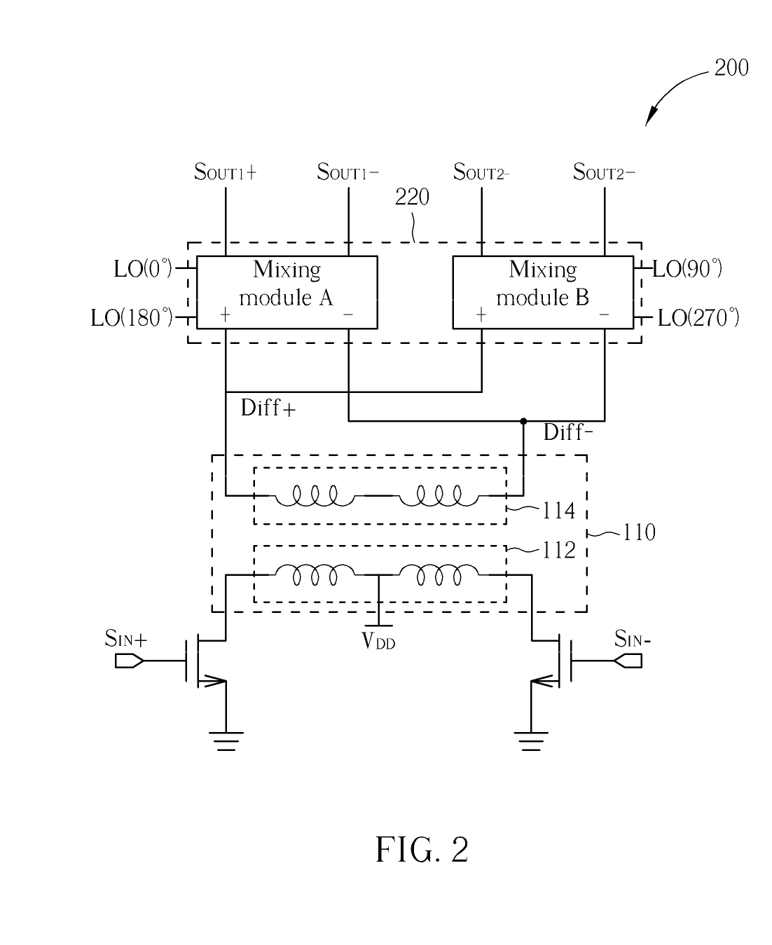

In another embodiment shown in FIG. 2, the transformer 210 in the mixer 200 of the present invention transforms a differential input formed by the signals SIN+ and SIN− into a differential output composed of signals Diff+ and Diff−, which are coupled to the mixing circuit 220 and then mixed with the oscillating signals LO(0), LO(90), LO(180) and LO(270) to generate the mixed output signals SOUT1+ and SOUT1− and SOUT2+, SOUT2−. In short, the present invention primarily employs a transformer to perform the single/differential transform or signal coupling upon the signals. Besides, the transformer in the present invention may be a balun transformer.

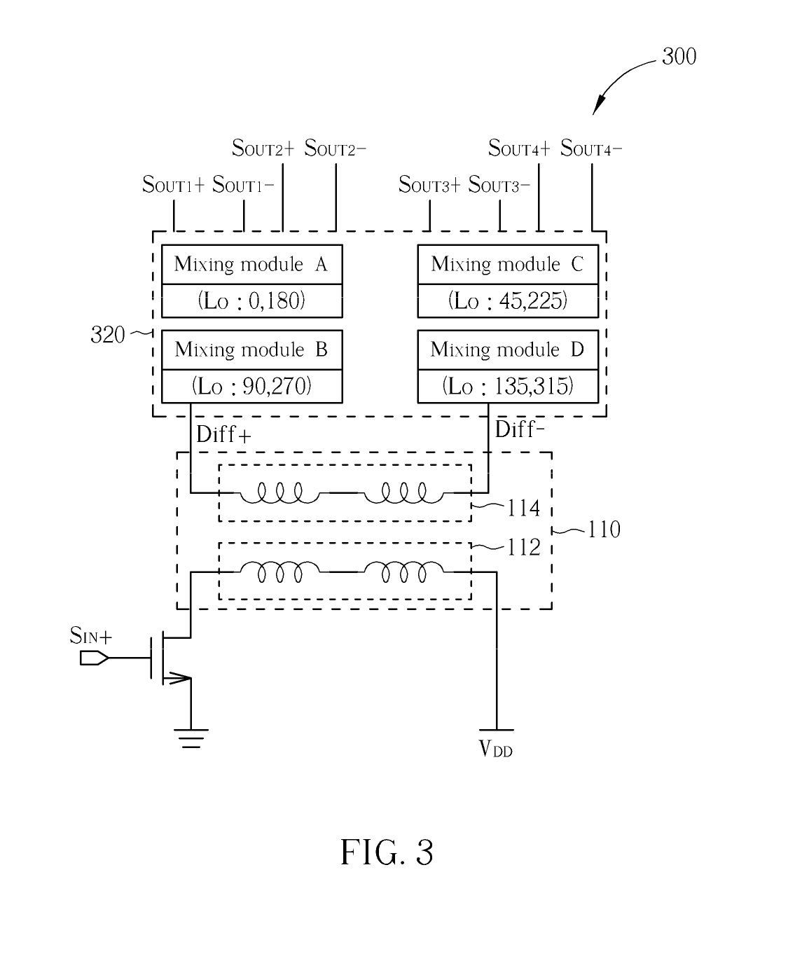

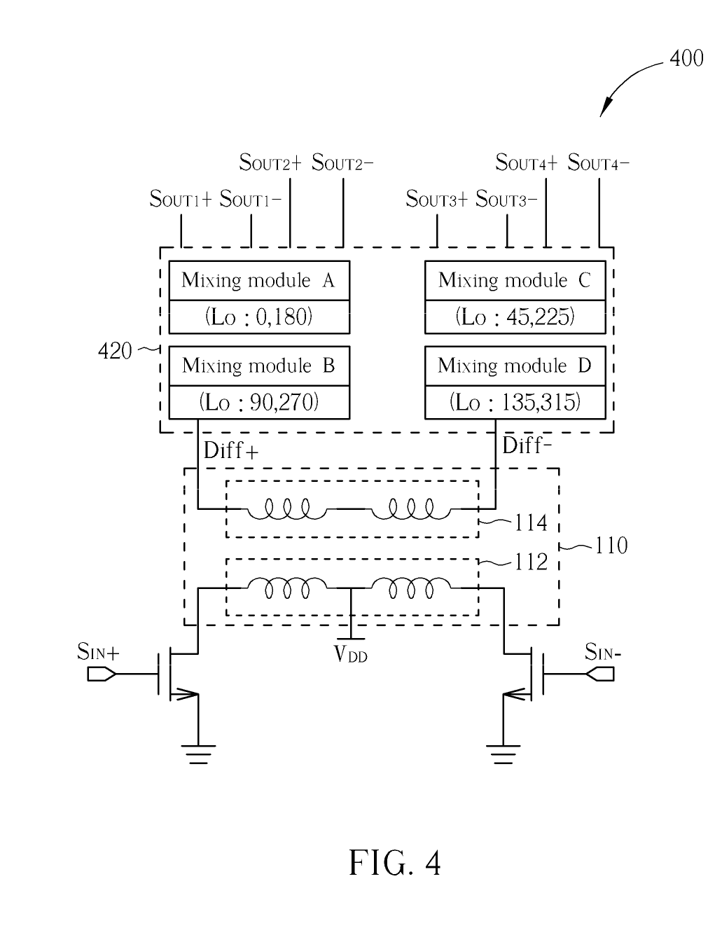

Additionally, though the aforementioned embodiments are suitable for mixing the input signal with the oscillating signals having four phases (LO(0), LO(90), LO(180) and LO(270)), the mixer of the present invention may also be properly modified to be applied to oscillating signals having more phases. The embodiments shown in FIG. 3 and FIG. 4 illustrate how to use the transformer to execute the balun transform and/or signal coupling and mix the differential output composed of signals Diff+ and Diff− with oscillating signals having eight phases. Please refer to FIG. 3 and FIG. 4, which are diagrams illustrating the structure of the mixer according to other embodiments of the present invention. As shown in FIG. 3, the mixer 300 may transform the single-ended input signal S into signals Diff+ and Diff− via the transformer 110, and mix the signals Diff+ and Diff− with the oscillating signals having eight phases LO(0), LO(45), LO(90), LO(135), LO(180), LO(225), LO(270) and LO(315) to generate mixed output signals SOUT1+ and SOUT1−, SOUT2+ and SOUT2−, SOUT3+ and SOUT3−, and SOUT4+ and SOUT4−. In the embodiment shown in FIG. 4, the mixer 400 transforms the differential input composed of signals SIN+ and SIN− into signals Diff+ and Diff− and couples the signals Diff+ and Diff− to the mixing circuit 410. And the signals Diff+ and Diff− are mixed with the oscillating signals having eight phases LO(0), LO(45), LO(90), LO(135), LO(180), LO(225), LO(270) and LO(315) to generate the mixed output signals SOUT1+ and SOUT1−, SOUT2+ and SOUT2−, SOUT3+ and SOUT3−, and SOUT4+ and SOUT4−. It can be known from the aforementioned embodiments, the mixer of the present invention may mix the input signal (e.g., a single-ended input signal S or a differential input signal composed of signals SIN+ and SIN−) with oscillating signals having multiple phases, wherein the number of the phases is not limited. In other embodiment of the present invention, it only requires the proper modification of the mixing circuit (for example, more mixing modules added thereto) to mix the input signal with oscillating signals having more phases.

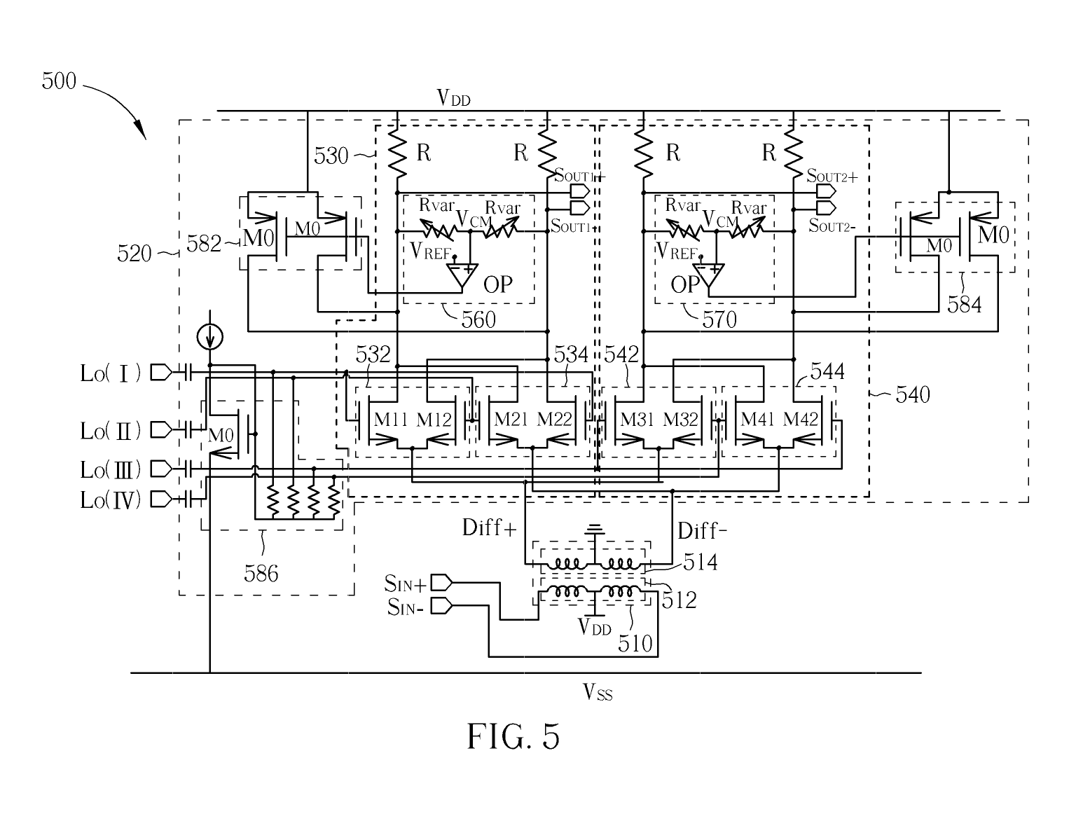

Regarding the detailed circuit structure of the mixer of the present invention, please refer to FIG. 5. The mixer 500 is used to mix a differential input signal composed of SIN+ and SIN− with the oscillating signals having four phases LO(I), LO(II), LO(III) and LO(IV) to obtain the mixed output signals SOUT1+ and SOUT1−, and SOUT2+ and SOUT2−. Further description is detailed as below. First, the transformer 510 couples the differential input signal composed of SIN+ and SIN− to the mixing circuit 520 via the first coil 512 and the second coil 514. Please note that, when the arrangement of the connection of the transformer 510 is changed/modified, the transformer may be used to transform the single-ended input signal into the differential output signal, and couple the differential output signal to the mixing circuit 520. Such change also falls within the scope of the present invention. Additionally, both the first coil 512 and the second coil 514 may be implemented by any inductive elements. For example, the first coil 512 may be the inductive load of the previous stage of the circuit. The mixing circuit 520 includes the mixing module 530 and the mixing module 540, wherein the mixing module 530 is used to mix the signals Diff+ and Diff− transformed from the differential input signal composed of SIN+ and SIN− with the oscillating signals LO(I) and LO(II) (preferably, there is a 180-degree phase difference between the oscillating signals LO(I) and LO(II)) to generate the mixed output signals SOUT1+ and SOUT1−. And the mixing module 540 is used to mix the signals Diff+ and Diff− with the oscillating signals LO(III) and LO(IV) (preferably, there is a 180-degree phase difference between the oscillating signals LO(III) and LO(IV)) to generate the mixed output signals SOUT2+ and SOUT2−. Besides, the mixing module 530 and the mixing module 540 include a common-mode feedback circuit 560 and a feedback circuit 570 for controlling the common-mode voltages at output nodes of the mixing module 530 and the mixing module 540 to make the common-mode voltages maintained at the ideal level, respectively. It should be noted that the common-mode feedback circuits 560 and 570 are not elements indispensable to the mixer 500 of the present invention.

The mixing module 530 includes differential pair circuits 532 and 534 each formed by a pair of transistors, wherein the differential pair circuit 532 is formed by the transistors M11 and M12, and the differential pair circuit 534 is formed by the transistors M21 and M22. The gates of the transistor M11 and the transistor M12 are used as a positive input node and a negative input node respectively, to receive the oscillating signals LO(I) and LO(II), and the gates of the transistor M21 and the transistor M22 are used as a positive input node and a negative input node respectively, to receive the oscillating signals LO(II) and LO(I). Moreover, the sources of the transistors M11 and M12 are coupled to each other and used to receive the signal Diff+, and the sources of the transistors M21 and M22 are also coupled to each other and used to receive the signal Diff−. That is, the oscillating signals LO(I) and LO(II) are inputted to the mixing circuit 520 by the gates of the transistors in the differential circuits 532 and 534, and the signals Diff+ and Diff− generated from the input signal are inputted to the mixing circuit 520 by the sources of the transistors in the differential pair circuits 532 and 534. Based on the square law of the transistor, the drains of the differential pair circuits 532 and 534 will generate the mixed output signals SOUT1+ and SOUT1−, resulting from the mixing of the differential inputs SIN+ and SIN− with the oscillating signals LO(I) and LO(II). Besides, if the mixer 500 is a mixing element in the receiver, the mixed output signals SOUT1+ and SOUT1− may be intermediate frequency signals or baseband signals, and the input signals SIN+ and SIN− may be radio frequency signals.

Similarly, the mixing module 540 includes the differential pair circuits 542 and 544, wherein the differential pair circuit 542 is formed by the transistors M31 and M32, and the differential pair circuit 544 is formed by the transistors M41 and M42. The gates of the transistors M31 and M32 are used as a positive input node and a negative input node to receive the oscillating signals LO(III) and LO(IV), the gates of transistor M41 and M42 are used as the negative input node and the positive input node respectively to receive oscillating signals LO(IV) and LO(111). Moreover, the sources of the transistors M31 and M32 are coupled to each other and used to receive the signal Diff+, and the sources of the transistors M41 and M42 are also coupled to each other and used to receive the signal Diff−. That is, the oscillating signals LO(III) and LO(IV) are inputted to the mixing circuit 520 by the differential pair circuits 542 and 544, and signals Diff+ and Diff− generated from the input signal are inputted to the mixing circuit 520 by the sources of the transistors in the differential pair circuits 542 and 544. Based on the square law, the drains of the transistors of the differential pair circuits 542 and 544 will generate the mixed output signals SOUT2+ and SOUT2−, resulting from the mixing of the differential inputs SIN+ and SIN− with the oscillating signals LO(III) and LO(IV). Similarly, if the mixer 500 is a mixing element in the receiver, the mixed output signals SOUT2+ and SOUT2− may be intermediate frequency signals or baseband signals, and the input signals SIN+ and SIN− may be radio frequency signals.

As can be known from above, the mixer 500 uses the transformer 510 to couple the input signals SIN+ and SIN− to the mixing circuit 520, and the mixing circuit 520 actually uses the differential pair circuits 532-534 to mix the signals. Moreover, the mixer 500 further includes circuits 582-586 to bias the common-mode feedback circuits 560, 570 and the transistors M11-M42. However, the structure, arrangement and existence of these circuits are not meant to be limitations of the present invention.

Please note that, though the signals SIN+ and SIN− are inputted to the differential pair circuits 532-534 via the sources of the transistors. However, in other embodiments of the present invention, the signals SIN+ and SIN− may be coupled to the differential pair circuits 532-534 via the drains of the transistors, and use the relationship between the voltage and the current of the transistor to achieve the mixing operation (since the square law may have modified items resulting from the channel effect, the voltage difference between the gate and the drain may make the output terminal generate the related mixed result). Besides, it should also be noted that, the number of the differential pairs and/or the number of the mixing modules in the above embodiments are not meant to be limitations to the present invention. That is, these numbers may depend on the number of the phases of the oscillating signals. For example, in an embodiment of performing the mixing by using eight phases, each of the number of the differential pairs in the mixer and the number of the mixing modules may be twice as large as that in the embodiment mentioned above. Moreover, in the embodiment mentioned above, though the transistors M11-M42 are all N-type MOS transistors, but in other embodiments of the present invention, transistors M11-M42 may be P-type MOS transistors, a combination of N-type MOS transistors and P-type MOS transistors, or transistors of other types.

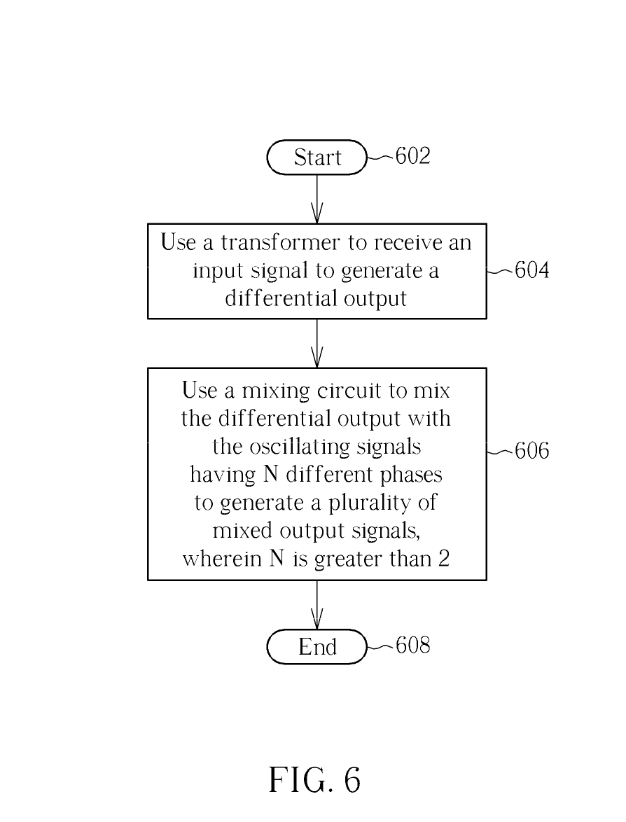

Based on the operation and effect of the mixer mentioned above, the present invention further provides a mixing method, as shown in the flowchart in FIG. 6. The mixing method may be used to mix the single-ended or differential input signal with the oscillating signal having multiple phases. First, in step 604, a transformer is used to receive an input signal to generate a differential output. Next, in step 606, a mixing circuit mixes the differential output with the oscillating signals having N different phases to generate a plurality of mixed output signals, wherein N is greater than 2. Please note that, if the result is substantially the same, the flowchart shown in FIG. 6 may have other additional steps inserted thereto, and such variation also belongs to the scope of the present invention.

In an embodiment of the method of the present invention, the step of generating the mixed output signals further includes: inputting the oscillating signals having different phases to the mixing circuit respectively, wherein the positive input node and the negative input node are gates of transistors of a differential pair. Moreover, the differential output may be inputted to the mixing circuit via one of the source and drain of the transistor for generating the mixed output signal. Since the operational base of the mixing method of the present invention is the mixer discussed in the aforementioned embodiment, the mixer and the mixing method would have the same concept, operation and effect. Further description of the details of the mixing method of the present invention is omitted for brevity.

One of the advantages of the mixer and mixing method of the present invention is the excellent high-frequency characteristic. In the near future, with the development and advance of the wireless communication theory, there may be new requirement for a multi-phase mixer, like the number of the phases of the oscillating signals which can be mixed by the multi-phase mixer or mixer's high-frequency response characteristic. Hence, when the number of phases increases, implementing the traditional mixer with a Gilbert cell may have a bottleneck due to poor high-frequency response. Therefore, the mixer employing a Gilbert cell structure is not preferred when the number of the phases increases. In comparison, since the mixer and mixing method of the present invention actually employ the transformer to couple the signals, the input stage is substantially the transformer. As the coil in the transformer has inductive characteristic, the coil may resonate with the equivalent capacitor at the input node of the mixer, thereby extending the bandwidth of the mixer. Hence, the mixer and mixing method of the present invention are particularly suitable for realizing the mixing circuit in the receiver due to excellent high-frequency characteristics. Specifically, the high-frequency response is not degraded when the number of phases of the oscillating signal increases.

Those skilled in the art will readily observe that numerous modifications and alterations of the device and method may be made while retaining the teachings of the invention. Accordingly, the above disclosure should be construed as limited only by the metes and bounds of the appended claims.

1. A mixer, comprising:
a transformer, for receiving an input signal to generate a differential output; and
a mixing circuit, coupled to the transformer, for mixing the differential output with N oscillating signals to generate a plurality of mixed output signals, wherein each of the N oscillating signals has a different phase from the other of the N oscillating signals, and N is greater than 2.

2. The mixer of claim 1, wherein the transformer is a balun transformer.

3. The mixer of claim 1, wherein the input signal is a differential input.

4. The mixer of claim 1, wherein the mixing circuit includes N differential pair circuits, each differential circuit comprise a positive input node and a negative input node, and the N oscillating signals having different phases are inputted to the mixing circuit through positive input nodes and negative input nodes of the N differential pair circuits, respectively.

5. The mixer of claim 4, wherein each differential pair circuit comprises a first transistor and a second transistor.

6. The mixer of claim 5, wherein gates of the first transistor and the second transistor serve as the positive input node and the negative input node, respectively.

7. The mixer of claim 5, wherein the differential output is fed into the mixing circuit through sources of the first transistor and the second transistor, respectively.

8. The mixer of claim 5, wherein the differential output is fed into the mixing circuit through drains of the first transistor and the second transistor, respectively.

9. The mixer of claim 1, wherein a frequency of the input signal is higher than a frequency of each of the mixed output signals.

10. A receiver comprising the mixer of claim 1.

11. A mixing method applied to a mixing circuit, comprising:
generating a differential output from an input signal by utilizing a transformer; and
mixing the differential output with N oscillating signals by utilizing the mixing circuit to generate a plurality of mixed output signals, wherein each of the N oscillating signals has a different phase from the other of the N oscillating signals, and N is greater than 2.

12. The mixing method of claim 11, wherein the transformer is a balun transformer.

13. The mixing method of claim 11, wherein the input signal is a differential input.

14. The mixing method of claim 11, wherein the mixing circuit includes N differential pair circuits, each differential pair circuit has a positive input node and a negative input node, and the step of mixing the differential output with N oscillating signals having different phases by utilizing the mixing circuit to generate a plurality of mixed output signals comprises:
inputting the N oscillating signals having different phases to the mixing circuit through the positive input nodes and the negative input nodes of the N differential pair circuits, respectively.

15. The mixing method of claim 14, wherein each differential pair circuit comprises a first transistor and a second transistor.

16. The mixing method of claim 15, wherein gates of the first transistor and the second transistor serve as the positive input node and the negative input node, respectively.

17. The mixing method of claim 15, wherein the step of mixing the differential output with N oscillating signals having different phases by utilizing the mixing circuit to generate a plurality of mixed output signals:
inputting the differential output to the mixing circuit through sources of the first transistor and the second transistor, respectively.

18. The mixing method of claim 15, wherein the step of mixing the differential output with N oscillating signals having different phases by utilizing the mixing circuit to generate a plurality of mixed output signals:
inputting the differential output to the mixing circuit through drains of the first transistor and the second transistor, respectively.

19. The mixing method of claim 11, wherein a frequency of the input signal is higher than a frequency of each of the mixed output signals.
